(19) United States
(12) Patent Application Publication
(10) Pub. No.: US 2021/0267224 A1
(43) Pub. Date: Sep. 2, 2021

(54) COMPOSITION AND PROCESS FOR LONG TERM PRESERVATION OF FOOD

(71) Applicant: INDEPENDENT QUALITY FOODS, LLC, Fayetteville, AR (US)

(72) Inventor: Brandon Lobaugh, Fayetteville, AR (US)

(21) Appl. No.: 17/186,558

(22) Filed: Feb. 26, 2021

Related U.S. Application Data
(60) Provisional application No. 62/982,438, filed on Feb. 27, 2020.

(51) Int. Cl. A23B 4/06; A23L 3/36; A23L 3/00; A23L 13/70; B65B 25/00; G06Q 10/08; G06Q 30/00

(52) U.S. Cl. CPC A23B 4/068; A23L 3/364; A23L 3/001; A23L 13/70; A23V 2002/00; G06Q 10/087; G06Q 10/0832; G06Q 30/018; B65B 25/001

(57) ABSTRACT

Provided is a method of fresh preserving meat products by controlling the intake process of the packaged meat, storing the meat in a temperature-controlled environment the keeps the meat at or near the freezing point of the meat without forming or growing ice crystals, and shipping the meat at a time where the seasonal price of the meat is favorable.

### CROSS-REFERENCE TO RELATED APPLICATIONS

This application claims the benefit of U.S. Ser. No. 62/982,438, filed Feb. 27, 2020, which is herein incorporated by reference in its entirety.

### FIELD

The present application relates generally to the field of preservation of perishable materials, such as food or tissue. Specifically, the present application is directed in some respects to methods and systems for food preservation capable of preserving the freshness of food products while stored at temperatures above or near the products' freezing point without forming ice crystals or using chemical preservatives.

### DESCRIPTION OF THE RELATED ART

Properly preserving foods, especially meats, is an economic and personal and public health issue. Several methods for preserving foods include temperature control and chemical preservation, in which degradative enzyme or microbial activity is slowed. Freezing is one of the more common and effective methods for ensuring the food safety and quality over long storage periods. Despite its effectiveness, freezing and thawing can negatively affect food quality. For example, the process ice formation and crystal growth can result in irreversible damage to tissue structures in meat and fish (and other foods) as well as effect changes in the color, taste, and freshness of the food. Food products subjected to prolonged freezing may also experience lipid oxidation, protein denaturation, ice recrystallization, and changes in the moisture content—processes directly related structural damages due to formation, growth, and distribution of ice crystals within the food products.

Several technologies have been developed to manage the negative impact of freezing and thawing on food quality. Most of these technologies focus on quick freezing of water by instant nucleation or by controlling the size of ice crystals through external force. U.S. Pat. No. 4,396,636 describes a stepwise method of freezing starting at −80 to −100 degrees Celsius to form an ice shell around the food, followed by chilling at −25 to −35 degrees Celsius to bring the core to 0 degrees Celsius, and followed by quick freezing at −80 to −100 degrees Celsius to bring the core to −6 degrees Celsius and storing at −18 to −20 degrees Celsius until consumed.

U.S. Pat. No. 6,096,361 provides a method of preserving food by rapidly cooling the food to near the freezing point of the food and then slowly cooling the food below the freezing point of the food at a cooling rate of 0.01-0.5 degree Celsius per hour followed. The food is packages in material coated with an ice nucleation or growth inhibitor like glycerol, a glycoprotein, or gelatin.

U.S. Pat. No. 8,211,487 describes the application of biologically manufactured antifreeze molecules, which include collagen or gelatin hydrolysates with masses between 500 and 7,000 Daltons, to food before freezing to inhibit ice crystal growth in the frozen food.

U.S. Pat. No. 10,111,452 discloses a method for freezing food while reducing ice crystal formation. Here, the food product is cooled below the freezing point of water under a pulsed electric field and oscillating magnetic field, which influences the mobility of water molecules and impedes ice crystal formation.

While several quick freeze and other methods are available to ameliorate the deleterious effects of freezing food while managing to effect preservation, there remains a significant need for simple methods and systems for extending the freshness of food while retaining overall quality or actually improving overall quality—such as, in the case of meat, tenderness.

### SUMMARY

In a first aspect, the invention provides a packaged food product that is more than 20 days old and contains no chemical preservatives, no ice crystals, and no more than 1000 colony forming units of lactic acid bacteria or aerobic bacteria per gram of food product.

In one embodiment, the packaged meat is between 70 days and 120 days old. In one embodiment, the packaged meet has less than 5% purge, less than 4% purge, less than 3% purge, less than 2% purge, less than 1% purge, or less than 0.5% purge.

In one embodiment, the packaged meat is produced according to a method that includes the steps of (a) receiving packaged food (i.e., product) from a food distributor, usually palletized and on a trailer, (b) inspecting the packages (e.g., pallets) for any visible damage, (c) measuring the temperature of product from at least three loci, e.g., from the nose, the middle, and the tail of the trailer, (d) checking for leaking packages of food by opening six or more cases that contain the packaged food, (e) documenting the number of leaking packages if any, (f) remove any shrink wrapping, if any, from each pallet of encased and packaged food and then record information for every case and pallet on a manifest, (g) rope wrapping each pallet, (h) placing the pallets in a temperature-controlled storage room, and (j) monitoring the stored product for sensory characteristics. In one embodiment, the one or more of the following data points are recorded for each product: (i) product code, (ii) order number, (iii) purchase order number, (iv) packer identity, (v) storage location, (vi) number of cases, (vii) weight, (viii) warehouse lot number, (ix) delivery date, (x) packing dates, and (xi) fresh age (e.g., in the case of meat, the date of slaughter).

In one embodiment, the food product is meat. In a more specific embodiment, the meat is beef.

In one embodiment, the temperature-controlled storage room is maintained at a temperature that is the initial freezing point of meat, plus or minus 5 degrees Celsius.

In one embodiment, the monitoring for sensory characteristics include one or both of feeling the food product to make sure ice crystallization has not taken place and checking the packaged food product for the presence of any visible ice inside the packaging.

In a second aspect, the invention provides a method of preserving meat without using chemical preservatives, without forming ice crystals in the meat or package containing the meat, and while keeping the bacterial count below 1000 colony forming units per gram of meat for more than 20 days. In one embodiment, the preserving process reduces purge. In another embodiment, the preserving process maintains the red color of the meat.

In one embodiment, the method includes the steps of (a) receiving packaged food (i.e., product) from a food distributor, usually palletized and on a trailer, (b) inspecting the packages (e.g., pallets) for any visible damage, (c) measuring the temperature of product from at least three loci, e.g., from the nose, the middle, and the tail of the trailer, (d) checking for leaking packages of food by opening six or more cases that contain the packaged food, (e) documenting the number of leaking packages if any, (f) remove any shrink wrapping, if any, from each pallet of encased and packaged food and then record information for every case and pallet on a manifest, (g) rope wrapping each pallet, (h) placing the pallets in a temperature-controlled storage room, and (j) monitoring the stored product for sensory characteristics. In one embodiment, the one or more of the following data points are recorded for each product: (i) product code, (ii) order number, (iii) purchase order number, (iv) packer identity, (v) storage location, (vi) number of cases, (vii) weight, (viii) warehouse lot number, (ix) delivery date, (x) packing dates, and (xi) fresh age (e.g., in the case of meat, the date of slaughter).

In one embodiment, the food product is meat. In a more specific embodiment, the meat is beef.

In one embodiment, the temperature-controlled storage room is maintained at a temperature that is the initial freezing point of meat, plus or minus 5 degrees Celsius.

In one embodiment, the monitoring for sensory characteristics include one or both of feeling the food product to make sure ice crystallization has not taken place and checking the packaged food product for the presence of any visible ice inside the packaging.

In a third aspect, the invention provides a method of improving the taste or tenderness of meat by aging the meat without using chemical preservatives, without forming ice crystals in the meat or package containing the meat, and while keeping the bacterial count below 1000 colony forming units per gram of meat for more than 20 days. In one embodiment, the meat is preserved such that the activity of calpastatin is preferentially inhibited and the activity of calpain is not inhibited and thereby continues to naturally tenderize the meat over time.

In one embodiment, the method includes the steps of (a) receiving packaged food (i.e., product) from a food distributor, usually palletized and on a trailer, (b) inspecting the packages (e.g., pallets) for any visible damage, (c) measuring the temperature of product from at least three loci, e.g., from the nose, the middle, and the tail of the trailer, (d) checking for leaking packages of food by opening six or more cases that contain the packaged food, (e) documenting the number of leaking packages if any, (f) remove any shrink wrapping, if any, from each pallet of encased and packaged food and then record information for every case and pallet on a manifest, (g) rope wrapping each pallet, (h) placing the pallets in a temperature-controlled storage room, and (j) monitoring the stored product for sensory characteristics. In one embodiment, the one or more of the following data points are recorded for each product: (i) product code, (ii) order number, (iii) purchase order number, (iv) packer identity, (v) storage location, (vi) number of cases, (vii) weight, (viii) warehouse lot number, (ix) delivery date, (x) packing dates, and (xi) fresh age (e.g., in the case of meat, the date of slaughter).

In one embodiment, the food product is meat. In a more specific embodiment, the meat is beef.

In one embodiment, the temperature-controlled storage room is maintained at a temperature that is the initial freezing point of meat, plus or minus 5 degrees Celsius.

In one embodiment, the monitoring for sensory characteristics include one or both of feeling the food product to make sure ice crystallization has not taken place and checking the packaged food product for the presence of any visible ice inside the packaging.

In a fourth aspect, the invention provides a method for managing the price of meat by taking advantage of seasonal price differences, thereby enabling the sale of meat at higher prices than when initially procured, by preserving the meat for at least 70 days while maintaining low bacteria counts, high visual appeal, and improved tenderness.

In one embodiment, the method includes (1) the step of preserving the meat by (a) receiving packaged meat (i.e., product) from a food distributor, usually palletized and on a trailer, (b) inspecting the packages (e.g., pallets) for any visible damage, (c) measuring the temperature of product from at least three loci, e.g., from the nose, the middle, and the tail of the trailer, (d) checking for leaking packages of food by opening six or more cases that contain the packaged food, (e) documenting the number of leaking packages if any, (f) remove any shrink wrapping, if any, from each pallet of encased and packaged food and then record information for every case and pallet on a manifest, (g) rope wrapping each pallet, (h) placing the pallets in a temperature-controlled storage room, and (j) monitoring the stored product for sensory characteristics; and (2) the step of selling the preserved meat when the price of meat is favorable.

In one embodiment, the one or more of the following data points are recorded for each product: (i) product code, (ii) order number, (iii) purchase order number, (iv) packer identity, (v) storage location, (vi) number of cases, (vii) weight, (viii) warehouse lot number, (ix) delivery date, (x) packing dates, and (xi) fresh age (e.g., in the case of meat, the date of slaughter).

In one embodiment, the meat is beef.

In one embodiment, the temperature-controlled storage room is maintained at a temperature that is the initial freezing point of meat, plus or minus 5 degrees Celsius.

In one embodiment, the monitoring for sensory characteristics include one or both of feeling the food product to make sure ice crystallization has not taken place and checking the packaged food product for the presence of any visible ice inside the packaging.

### DRAWINGS

The accompanying drawings, being incorporated in and forming a part of this specification, illustrate embodiments of the invention and, together with the description, serve to explain the principles of the present invention:

FIG. 1 is a flow chart depicting steps for preserving and monitoring meat.

FIG. 2 is a hierarchy chart depicting data point categories.

FIG. 3 is a hierarchy chart depicting temperature control parameters.

FIG. 4 is a hierarchy chart depicting quality control steps.

FIG. 5 is a bar chart depicting tenderness (Y-axis) of meat samples (X-axis). Panel A depicts subjective tenderness on a scale of 1 to 8, with 1 being extremely tough and 8 being extremely tender. Panel B depicts objective tenderness with the Y-axis depicting shear force in kilograms.

FIG. 6, panel A is a bar chart depicting juiciness (Y-axis) of meat samples (X-axis) on a scale of 1 to 8, with 1 being extremely dry and 8 being extremely juicy.

FIG. 6, panel B is a bar chart depicting flavor (Y-axis) of meat samples (X-axis) on a scale of (1=no presence; 3=strong flavor) for both beef flavor (left section) and off flavor (right section).

### DETAILED DESCRIPTION

Reference will now be made in detail to certain embodiments of the invention, with examples illustrated in the accompanying drawings. The invention is described in conjunction with the certain embodiments, however, it will be understood that the certain embodiments are not intended to limit the invention. The invention is intended to cover alternatives, modifications and equivalents included, now or later, within the spirit and scope of the present invention as defined by the appended claims or claims appended to related patent applications having the same written description.

As used herein, the term “about” means plus or minus 15% of the stated volume, mass, or temporal value. For example, the term “about 100 pounds” means 100 pounds±15 pounds or 85 pounds to 115 pounds; about 10 days±1.5 days or 8.5 to 11.5 days. As used herein, the term “about” means plus or minus 1° C. (for temperature in Celsius units) or plus or minus 1.8° F. (for temperature in Fahrenheit units).

Applicant has made the surprising discovery that meat maintains freshness, low bacterial counts, and better quality for an extended period when stored at a temperature close to or at the freezing point of meat. Here, the extended period enables the sale of the subject preserved meat when the price of meat is more or most favorable relative to the time of initial procurement of the meat by the entity that preserves the meat (i.e., the “Preserver”). While the state of the art may describe methods for preserving meat for extended periods by freezing the meat to at close to −20 degrees Celsius (or 0 degrees Fahrenheit) core temperature, which utilizes steps and machines to control ice crystal formation and/or growth, there is no teaching in the art or expectation of success for simple storage of meat at a temperature at or near the freezing temperature of the meat where calpastatin activity is reduced and calpain activity continues.

In one specific embodiment of the invention, the Preserver receives packaged meat from a meat packer and records at the temperature of the packaged meat at the time of receipt of the meat. In one embodiment, a single temperature measurement is taken and recorded from a single locus in the trailer in which the packaged meat was transported. In another embodiment, one to five or two to ten temperature measurements are taken from one, two, three, four, five, six, seven, eight, nine, ten, eleven, twelve, thirteen, between one and five, between three and ten, between two and twenty, or between three and twenty-five loci in the trailer in which the meat was transported. In one embodiment, the one or more temperature measurements are taken from random loci, or at least one from at or near the center of the trailer, at or near the front of the trailer, at or near the back of the trailer, or at least one from the front and at least one from the front of the trailer, or at least one or more from each of the front, middle, and back of the trailer.

If the temperature of the meat as measured in the trailer is above or below a particular acceptable temperature or temperature range, then, in one embodiment, the packaged meat is rejected and not further processed.

In one embodiment, the particular acceptable temperature or temperature range is −7° C. to 11° C., −7° C. to 0° C., −6° C. to 1° C., −5° C. to 2° C., −4° C. to 3° C., −3° C. to 4° C., −2° C. to 5° C., −1° C. to 6° C., 0° C. to 7° C., 1° C. to 8° C., 2° C. to 9° C., 3° C. to 10° C., 4° C. to 11° C., about −7° C., about −6° C., about −5° C., about −4° C., about −3° C., about −2° C., about −1° C., about 0° C., about 1° C., about 2° C., about 3° C., about 4° C., about 5° C., about 6° C., about 7° C., about 8° C., about 9° C., about 10° C., about 11° C., 19° F. to 52° F., 19° F. to 30° F., 20° F. to 31° F., 21° F. to 32° F., 22° F. to 33° F., 23° F. to 34° F., 24° F. to 35° F., 25° F. to 36° F., 26° F. to 37° F., 27° F. to 38° F., 28° F. to 39° F., 29° F. to 40° F., 30° F. to 41° F., 31° F. to 42° F., 32° F. to 43° F., 33° F. to 44° F., 34° F. to 45° F., 35° F. to 46° F., 36° F. to 47° F., 37° F. to 48° F., 38° F. to 49° F., 39° F. to 50° F., 40° F. to 51° F., 41° F. to 52° F., about 19° F., about 20° F., about 21° F., about 22° F., about 23° F., about 24° F., about 25° F., about 26° F., about 27° F., about 28° F., about 29° F., about 30° F., about 31° F., about 32° F., about 33° F., about 34° F., about 35° F., about 36° F., about 37° F., about 38° F., about 39° F., 40° F., about 41° F., about 42° F., about 43° F., about 44° F., about 45° F., about 46° F., about 47° F., about 48° F., about 49° F., about 50° F., about 51° F., or about 52° F.

In one embodiment, after the temperature of the received packaged meat is measured and if the shipment is accepted, then one or more cases containing the packaged meat is/are opened and inspected for leakage. If any leaking packages are found, the finding is documented. In some embodiments, the leaking package is discarded. In other embodiments, the shipment is rejected.

In one embodiment, the number of cases that are opened per load and inspected for leaking packages is 1 to 10, 2 to 20, 3 to 30, 1 to 5, 2 to 10, 3 to 6, 4 to 7, 2 to 9, 1, 2, 3, 4, 5, 6, 7, 8, 9, 10, 11, 12, 13, 14 or 15.

In one embodiment, for the Preserver to accept the shipment of meat, the age of the meat must be less than about 18 days, less than about 17 days, less than about 16 days, less than about 15 days, less than about 14 days, less than about 13 days, less than about 12 days, less than about 11 days, less than about 10 days, less than about 9 days, less than about 8 days, less than about 7 days, less than about 6 days, less than about 5 days, less than about 4 days, less than about 3 days, less than about 2 days, less than about 1 day, or between 0 and 7 days.

In one embodiment, what is meant by “age of meat” is the time since the animal was slaughtered. In another embodiment, what is meant by “age of meat” is the time since the animal was butchered.

In one embodiment, the bacterial load of the packaged meat is not measured prior to accepting the shipment of meat or further downstream processing. In other words, upon receiving the packaged meat, the Preserver does not sample the packaged meat for the presence of any bacteria, such as, e.g., APC (aerobic plate counts), total plate counts, or LAB (lactic acid bacteria) counts. In another embodiment, samples of the packaged meat are optionally tested for the presence and/or titer (i.e., colony forming unites per gram of meat [CFU/g]) of bacteria.

After the Preserver accepts the shipment of meat, all shrink wrap, if any, is removed from the palletized product prior to placing the meat product into a temperature-controlled environment. In one embodiment, the cases of packaged meat are arranged or re-stacked into a conformation that enhanced air circulation. In another embodiment, the cases of packaged meat are not arranged or re-stacked into another stack conformation.

In one embodiment, the unwrapped meat product (i.e., the accepted shipment of meat product with the shrink wrap, if any, removed) is placed into a temperature-controlled environment. In some embodiments, the temperature-controlled environment is a walk-in refrigerator or freezer, a partitioned area within a work space or warehouse, or the like.

In one embodiment, the temperature of the temperature-controlled environment is kept within one-degree Fahrenheit or within one-half of one-degree Celsius of the freezing point of the meat. In some embodiments, the freezing point of the meat is with 5 degrees Fahrenheit or with 3 degrees Celsius of the freezing point of pure water at one atmosphere of pressure. placed into storage at 28 degrees Fahrenheit. In one embodiment, the temperature of the temperature-controlled environment is −3.5° C. to 3.5° C., −3° C. to 3° C., −25° C. to 2.5° C., −2° C. to 2° C., −1.5° C. to 1.5° C., −3° C. to −1° C., −3.5° C. to −1.5° C., −2.9° C. to −0.9° C., −2.8° C. to −1.6° C., −2.7° C. to −1.5° C., −3° C., −2.9° C., −2.8° C., −2.7° C., −2.6° C., −2.5° C., −2.4° C., −2.3° C., −2.2° C., −2.1° C., −2° C., −1.9° C., −1.8° C., −1.7° C., −1.6° C., −1.5° C., −1.4° C., −1.3° C., −1.2° C., −1.1° C., −1° C., −0.9° C., −0.8° C., −0.7° C., −0.6° C., −0.5° C., −0.4° C., −0.3° C., −0.2° C., −0.1° C., 0° C., 0.1° C., 0.2° C., 0.3° C., 0.4° C., 0.5° C., 0.6° C., 0.7° C., 0.8° C., 0.9° C., 1° C., 1.1° C., 1.2° C., 1.3° C., 1.4° C., 1.5° C., 1.6° C., 1.7° C., 1.8° C., 1.9° C., 2° C., 2.1° C., 2.2° C., 2.3° C., −3° C.±0.6° C., −2.9° C.±0.6° C., −2.8° C.±0.6° C., −2.7° C.±0.6° C., −2.6° C.±0.6° C., −2.5° C.±0.6° C., −2.4° C.±0.6° C., −2.3° C.±0.6° C., −2.2° C.±0.6° C., −2.1° C.±0.6° C., −2° C.±0.6° C., −1.9° C.±0.6° C., −1.8° C.±0.6° C., −1.7° C.±0.6° C., −1.6° C.±0.6° C., −1.5° C.±0.6° C., −1.4° C.±0.6° C., −1.3° C.±0.6° C., −1.2° C.±0.6° C., −1.1° C.±0.6° C., −1° C.±0.6° C., −0.9° C.±0.6° C., −0.8° C.±0.6° C., −0.7° C.±0.6° C., −0.6° C.±0.6° C., −0.5° C.±0.6° C., −0.4° C.±0.6° C., −0.3° C.±0.6° C., −0.2° C.±0.6° C., −0.1° C.±0.6° C., 0° C.±0.6° C., 0.1° C.±0.6° C., 0.2° C.±0.6° C., 0.3° C.±0.6° C., 0.4° C.±0.6° C., 0.5° C.±0.6° C., 0.6° C.±0.6° C., 0.7° C.±0.6° C., 0.8° C.±0.6° C., 0.9° C.±0.6° C., 1° C.±0.6° C., 1.1° C.±0.6° C., 1.2° C.±0.6° C., 1.3° C.±0.6° C., 1.4° C.±0.6° C., 1.5° C.±0.6° C., 1.6° C.±0.6° C., 1.7° C.±0.6° C., 1.8° C.±0.6° C., 1.9° C.±0.6° C., 2° C.±0.6° C., 2.1° C.±0.6° C., 2.2° C.±0.6° C., 2.3° C.±0.6° C., 26° F. to 38° F., 27° F. to 37° F., 28° F. to 36° F., 29° F. to 35° F., 30° F. to 34° F., 30° F. to 36° F., 26° F. to 30° F., 27° F. to 29° F., 26° F. to 29° F., 27° F. to 30° F., 27° F. to 31° F., 27° F. to 32° F., 26° F. to 33° F., 26° F. to 32° F., 24° F., 25° F., 26° F., 27° F., 28° F., 29° F., 30° F., 31° F., 32° F., 33° F., 34° F., 35° F., 36° F., 24° F.±1° F., 25° F.±1° F., 26° F.±1° F., 27° F.±1° F., 28° F.±1° F., 29° F.±1° F., 30° F.±1° F., 31° F.±1° F., 32° F.±1° F., 33° F.±1° F., 34° F.±1° F., 35° F.±1° F., or 36° F.±1° F.

In one embodiment, the temperature of the temperature-controlled environment (i.e., the storage temperature) is monitored remotely using wireless temperature loggers. In one embodiment, during temperature-controlled storage, visible ice crystals do not form or grow within the meat itself and/or within the packaging. In one embodiment, the meat is stored at a temperature at the lowest temperature before ice formation and/or growth occurs within the meat or the package. Thus, no ice crystal formation occurs within the stored meat, but microbial growth, oxidation, and most degradative enzyme activity is slowed or stopped. In one embodiment, the calpain activity continues within the meat, but at a reduced rate due to the reduced temperature.

In one embodiment, samples are removed from time-to-time from the stored accepted meat product (i.e., the accepted meat product that is stored in the temperature-controlled environment) and yeast/mold and/or bacterial counts (e.g., APC, TPC, LAB counts, and the like) are taken and measured for each removed sample (i.e., “micro-samples” are taken). In one embodiment, this “micro-sampling” is performed at receipt or immediately prior to or immediately after temperature-controlled storage (i.e., at receiving), at about day 10 of storage, at about day 15 of storage, at about day 20 of storage, at about day 25 of storage, at about day 30 of storage, at about day 45 of storage, at about day 60 of storage, at about day 75 of storage, at about day 90 of storage, or when the meat product ships from the Preserver to the customer (i.e., at shipping). In one embodiment, micro-sampling is performed at about receiving, at about day-30, at about day-60, and about shipping.

In an embodiment in which a shipment of packaged meat contain product from more than one meat packer, one or more micro-samples are taken and measured from meat product from each meat packer.

In one embodiment, one or more micro-samples are taken and measured from each cut of meat.

In one embodiment, one or more micro-samples are taken and measured from each storage location, temperature-controlled environment, and/or selected location within each temperature-controlled environment.

In one embodiment, there is little to no microbial growth in over 65 days of storage in the temperature-controlled environment. In another embodiment, there is no more than 0 to 7 logs, no more than 2 to 6 logs, no more than 3 to 5 logs, no more than 3.5 to 4.5 logs, no more than 4 to 5 logs, no more than 4.5 to 6 logs, or no more than 4.5 to 5 logs of bacteria or other microbes on the meat as determined by micro-sampling at 65 days of storage or longer. In another embodiment, there is no more than 2 to 6 logs, no more than 3 to 5 logs, no more than 3.5 to 4.5 logs, no more than 4 to 5 logs, no more than 4.5 to 6 logs, or no more than 4.5 to 5 logs of bacteria or other microbes on the meat as determined by micro-sampling at about 90-120 days or longer of storage.

As used herein, a “log” is the base ten power of the number of microbes or colony forming units per gram of meat. For example, 5 logs means 10⁵ CFU/g or 100,000 CFU/g; 4.5 logs means 10^{4.5} CFU/g or 31,623 CFU/g.

In one specific embodiment, the microbial load of the SUSPENDED FRESH meat product is less than about 3 logs at about day-60 and no more than about 1 log at about day-35. Table 1 depicts the microbial load on an export rib that was preserved according to the disclosed SUSPENDED FRESH process.

TABLE 1

| | | APC | Total LAB | | |
|---|---|---|---|---|---|
| Description | Day | cfu/g | cfu/g | Log APC | Log Total |
| Export Rib | 28 | 10 | 10 | 1.00 | 1.00 |
| Export Rib | 30 | 20 | 10 | 1.30 | 1.00 |
| Export Rib | 35 | 10 | 10 | 1.00 | 1.00 |
| Export Rib | 54 | 10 | 10 | 1.00 | 1.00 |
| Export Rib | 57 | 690 | 240 | 2.84 | 2.38 |

In one embodiment, prior to shipping, the temperature-controlled stored meat product (i.e., “preserved” meat product, also herein referred to as SUSPENDED FRESH (“SF”) product) is affixed with a label stating a use-by date of 28 to 35 days from the date of shipping from Preserver's facility. After labeling the packaged SUSPENDED FRESH product, the palletized product is wrapped and shipped in a temperature-controlled box truck, shipping container, polar bin trailer, or the like (collectively “container for shipping”). In one embodiment, the container for shipping maintains a temperature that is the same as the temperature of the temperature-controlled environment from which the SUSPENDED FRESH product was stored.

In one embodiment, the SUSPENDED FRESH meat product is sold and shipped to a client when the price of meat is higher than when the meat product was accepted or received by Preserver from the producer to take advantage of any seasonal market price advantages.

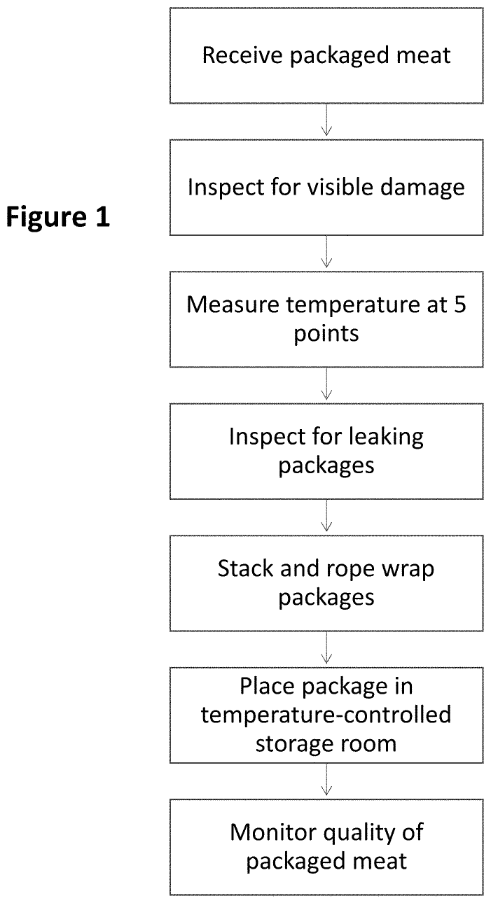

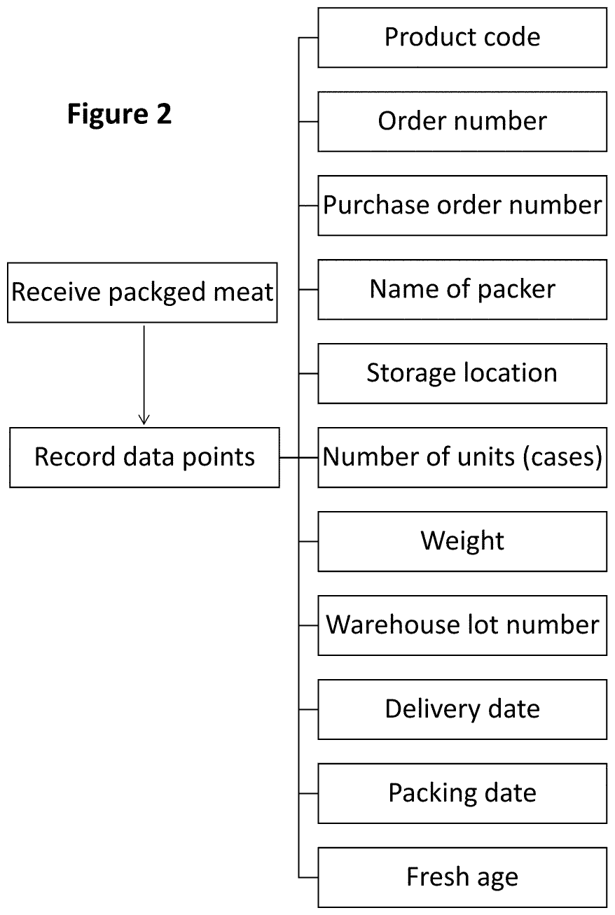

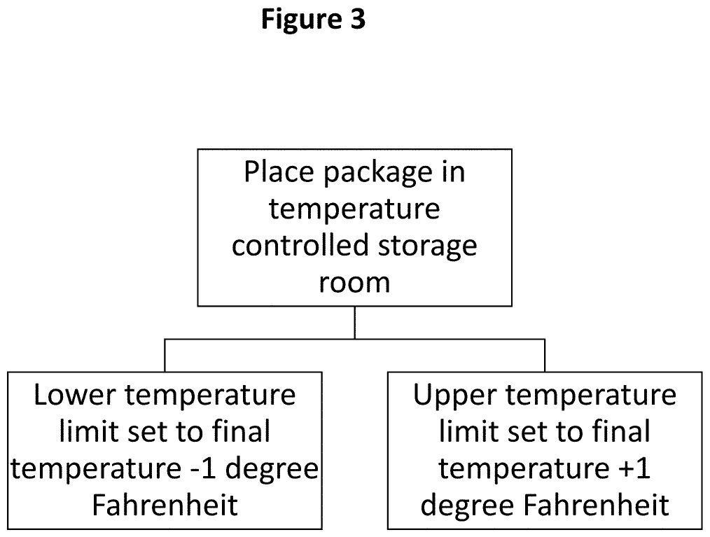

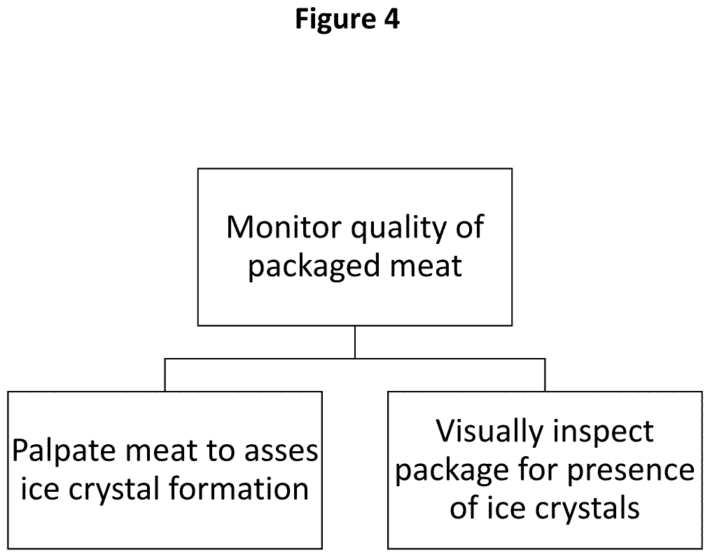

In one embodiment, the process for preserving meat includes the steps set forth in FIG. 1 and the steps and parameters as set forth in FIGS. 2-4.

In another aspect, the process for preserving meat product for an extended period of time, as described in this section above, produces a meat product that has improved visual, mouth feel, and taste qualities.

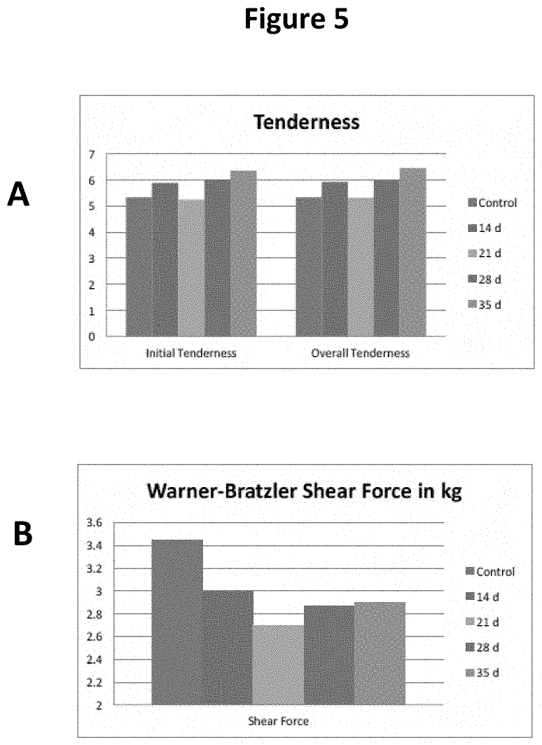

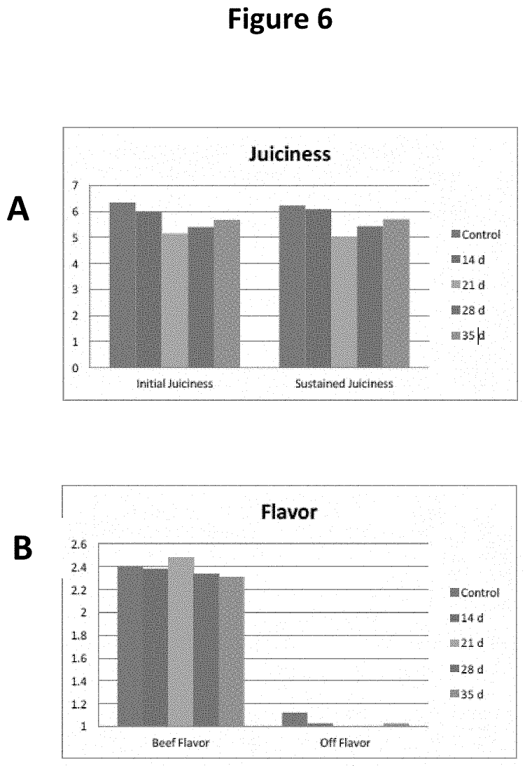

In one embodiment, the SUSPENDED FRESH meat product produced according to the disclosed process is (i) more tender than meat preserved by other methods, such as conventional freezing or quick freezing, or other prior art freezing methods (FIG. 5, panels A and B), and (ii) maintains its flavor and juiciness (FIG. 6, panels A and B). For example, SUSPENDED FRESH flank steak products that were preserved by the disclosed method and held in the temperature-controlled environment at 14, 21, 28 and 35 days were compared to control flank steaks that were 21 d aged fresh).

According to this example, steaks (n=3/package/treatment) were randomly selected for sensory evaluation (n=2) and objective tenderness (n=1) (i.e., as measured by the Warner-Bratzler Shear Force (WBS); see FIG. 5, panel B). Steaks were cooked on an impingement oven to an internal temperature of 70° C. following the guidelines of AMSA (2011). After cooking, the steaks for sensory evaluation were cut into cubes and sampled independently. Two pieces were placed in a sample cup with a lid, and placed in warmers to sustain heat before panel. Panelists were selected and trained following the guidelines from Cross et al. (1978) and Miller et al. (2011). Eight panelists were seated in individual booths in a temperature and light controlled room. Panelists were provided with distilled, deionized water and unsalted crackers to cleanse palate between samples. Samples were served under red lighting to avoid any bias for cooked beef color. Panelists evaluated each muscle for initial and sustained juiciness (8=extremely juicy; 1=extremely dry) (FIG. 6, panel A), initial and overall tenderness (8=extremely tender; 1=extremely tough) (FIG. 5, panel A), beef flavor (1=no presence; 3=strong flavor), off flavor (1=no presence; 3=strong flavor) (FIG. 6, panel B). The steaks for objective tenderness were cooled and then six ½ inch cores parallel to muscle fiber orientation. Cores were sheared using a standard Warner-Bratlzer testing machine. General observations were noted and graphic data presented in FIGS. 5 and 6. Averages were calculated for all steaks within treatment.

Very slight differences were noted among treatments for initial and sustained juiciness; all steaks were rated as slightly to moderately juicy. Control steaks and 14 day SUSPENDED FRESH were rated as least tender but only very minor differences as noted by trained panelists. Flank steaks at 35-days SUSPENDED FRESH were rated as the most tender initially and overall and very similar to 28-day SUSPENDED FRESH steaks. Again, all steaks were rated slightly to moderately tender by panelists. Control and 21-day SUSPENDED FRESH steaks were rated the lowest by trained panelists. Control steaks had WBS values of 3.4 kg, while all treatments had WBS values below 3.0 kg. Virtually no flavor differences were detected between treatments with all steaks have a presence of beef flavor and only extremely subtle off flavor noted by only 1 or 2 panelists depending on steak. Sensory ratings and WBS values clearly indicate that SUSPENDED FRESH product has high palatability rankings.

Meat products produced according to the disclosed method also show improved shelf life, and visual and taste appeal compared to other preserved or aged fresh beef products. In one example, the retail case-life (i.e., subjective and objective color), organoleptic, and sensory properties of SUSPENDED FRESH 60-day and 90-day ribeye and tenderloin steaks were compared to the same attributes of traditionally aged 21-day strips and tenderloins.

The following ribeyes and tenderloins samples were assessed for various properties and compared: SUSPENDED FRESH 60-day (SF60), SUSPENDED FRESH 90-day (SF90), and fresh 21-day. Cuts were stored for 7 days prior to fabrication. After storage, 5 one-inch steaks were cut from the provided products, (2=SF ribeyes, 2=SF tenderloins, 1=F ribeye, 1=F tenderloin/treatment). When vacuum package bags were opened, purge was measured, and product was evaluated for odor presence (0=no unpleasant odor; 1=mild unpleasant odor; 2=moderate unpleasant odor; 3=extremely unpleasant odor). Once steaks were cut they were then positioned in a polystyrene foam tray and overwrapped with poly-vinyl chloride overwrap. Each steak was subjectively and objectively evaluated for color attributes at 24-hour intervals during retail display for 3-7 day.

Color was subjectively evaluated by a six-person trained panel (panelists were trained using Munsell color tiles and were required to receive a passing score before participating on the color panel). Muscle color, overall appearance, and surface discoloration were evaluated by each panelist. Muscle color was characterized on an 8-point scale (8=extremely bright cherry red; 1=extremely dark red) as outlined in the Guidelines for Meat Color Evaluation (AMSA, 1991). Scores for overall appearance (8=extremely desirable; 1=extremely undesirable) and surface discoloration (7=100% discolored; 1=no discoloration) were assigned following the AMSA guidelines (AMSA, 1991).

Muscle color (longissimus; psoas major) for each steak was measured utilizing a hand held HunterLab MiniScan XE spectrophotometer equipped with a 6-mm aperture (HunterLab Associates, Inc., Reston, Va.) to determine values for CIE L* (brightness; 0=black, 100=white), a* (redness/greenness; positive values=red, negative values=green), and b* (yellowness/blueness; positive values=yellow, negative values=blue) by following the procedures of the Commission Internationale de I'Eclairage (CIE, 1976). Readings for each L*, a*, and b* were recorded for each day of the display phase.

Steaks were photographed during the afternoon of each day of display.

After the display period each package was opened and evaluated for any presence of undesirable odors (0=no odor; 3=extreme unpleasant odor).

At the end of display, steaks (n=3/treatment) were randomly selected for sensory evaluation. Steaks were cooked on an impingement oven to an internal temperature of 70° C. following the guidelines of AMSA (2011). After cooking each muscle was cut into cubes. Two pieces were placed in a sample cup with a lid, then placed in heated warmers prior to tasting. Panelists were selected and trained following the guidelines from Cross et al. (1978) and miller et al. (2011). Six to eight panelists were seated in individual booths in a temperature and light controlled room. Panelists were provided with distilled, deionized water and unsalted crackers to cleanse palate between samples. Samples were served under red lighting to avoid any bias for cooked beef color. Panelists evaluated each muscle for initial and sustained juiciness (8=extremely juicy; 1=extremely tough), beef, buttery, metallic, and livery flavor (8=very strong presence; 1=no presence).

General observations were noted, and the average scores were calculated for all steaks within treatment in this example. The SF60 and SF90 strips performed similarly (and in the case of SF60 if not slightly better for some parameters and time points) than the “fresh” strips with similar muscle color, discoloration and acceptability patterns.

As noted in the previous example above, shear force values indicated that the SUSPENDED FRESH products were more tender than the traditional fresh 21-day aged steaks. Sensory panel data was consistent with shear force data except for the SF-90-day aged tenderloins (where product was rated similar).

The present invention is not to be limited in scope by the specific embodiments described herein. Indeed, various modifications of the invention in addition to those described herein will become apparent to those skilled in the art from the foregoing description and accompanying figures. Such modifications are intended to fall within the scope of the appended claims.

What is claimed is:

1. A method for preserving meat comprising the sequential steps of (a) receiving packaged meat; (b) inspecting said packaged meat; (c) stacking or wrapping said packaged meat; (d) storing said packaged meat in a temperature-controlled room; (e) monitoring the quality of said packaged meat; and (f) shipping said packaged meat, wherein the meat has increased tenderness.

2. The method of claim 1 further comprising the step of labeling said packaged meat prior to shipping with a label, wherein said label comprises a use-by date.

3. The method of claim 1, wherein said inspecting at step (b) comprises visually inspecting for damage to packaging.

4. The method of claim 1, wherein said temperature-control room is set at a temperature that is at or near the freezing point of said meat with reduced or without the formation or growth of ice crystals in the muscle of the meat.

5. The method of claim 1, wherein said temperature-control room is set at a temperature of about that is at or near the freezing point of said meat without the formation or growth of ice crystals in the muscle of the meat.

6. The method of claim 1, wherein said temperature-control room is set at a temperature of about 26° F.-36° F.

7. The method of claim 1, wherein said quality of said packaged meat is monitored at step (e) by palpating the meat to assess ice crystal formation.

8. The method of claim 1, wherein said quality of said packaged meat is monitored at step (e) by visually inspecting the package for the presence of ice crystals.

9. The method of claim 1, wherein the packaged meat is stored in said temperature-controlled room for at least 30 days.

10. The method of claim 9, wherein the packaged meat is stored in said temperature-controlled room for at least 60 days.

11. The method of claim 10, wherein the packaged meat is stored in said temperature-controlled room for at least 90 days.

12. A system for preserving meat comprising: (a) a receiving room for receiving and inspecting packaged meat; and (b) a temperature-controlled storage room for holding and monitoring said packaged meat at a temperature at or near the freezing point of the meat without forming or growing ice crystals.

13. A preserved meat comprising (a) no chemical preservatives, (b) no ice crystals, and (c) less than 5 logs of microbes per gram, wherein said preserved meat is at least 15 days old and is more tender than fresh meat that has been aged for 21 days.

14. The preserved meat of claim 14, wherein said preserved meat is at least 30 days old.

15. The preserved meat of claim 14, wherein said preserved meat is at least 60 days old.

16. The preserved meat of claim 15, wherein said preserved meat is at least 90 days old.

17. The preserved meat of claim 16, wherein said preserved meat is at least 120 days old.
